(19) United States
(12) Patent Application Publication
(10) Pub. No.: US 2011/0158614 A1
(43) Pub. Date: Jun. 30, 2011

(54) MOTOR ROTATION SPEED CONTROL DEVICE AND METHOD THEREOF

(75) Inventors: Yen-Chien Cheng, Hsinchu City (TW); Chien-Liang Yeh, Kaohsiung City (TW); Shao-Lun Hung, Taichung County (TW)

(73) Assignee: SUNPLUS TECHNOLOGY CO., LTD., Hsinchu (TW)

(21) Appl. No.: 12/773,846

(22) Filed: May 5, 2010

(30) Foreign Application Priority Data
Dec. 30, 2009 (TW) 98145806

(51) Int. Cl. H02P 3/04

(52) U.S. Cl. 388/800

(57) ABSTRACT

A motor rotational speed control device for controlling a direct current (DC) brush motor is provided, which includes a motor driver, a detection unit and a central processing unit (CPU). The motor driver is coupled to a first control terminal and a second control terminal of the DC brush motor. The detection unit detects a back electromotive force (EMF) of the DC brush motor through the first control terminal and the second control terminal when the motor driver is set to a disable state, and accordingly generates back EMF information. The CPU determines whether the direct current brush motor has stopped rotating according to the back EMF information, and determines whether to generate a brake control signal according to a determination result. The motor driver reduces a rotation speed of the DC brush motor according to the brake control signal when the motor driver is set to an enable state.

### CROSS-REFERENCE TO RELATED APPLICATION

This application claims the priority benefit of Taiwan application serial no. 98145806, filed on Dec. 30, 2009. The entirety of the above-mentioned patent application is hereby incorporated by reference herein and made a part of specification.

### BACKGROUND OF THE INVENTION

1. Field of the Invention

The present invention relates to a motor rotation speed control device and a method thereof. More particularly, the present invention relates to a motor rotation speed control device of an optical storage system, and a method thereof.

2. Description of Related Art

A spindle motor is an operation axis of an optical storage system, and a function of the spindle motor is to support a disc and drive the disc to rotate, so that an optical pick-up unit (OPU) can continuously write/read signals onto/from a data track. Therefore, whether the spindle motor has a stable operation characteristic can directly influence an accessing speed of the optical storage system, and a rotation speed that can be achieved by the spindle motor also limits a highest reading speed of the optical storage system.

In an existing technique, a Taiwan Patent No. 584836 provides a disc rotation speed control device and a method thereof, in which a spindle motor parameter is calculated by detecting an armature current of the spindle motor, and the spindle motor parameter is used to measure and obtain a relative rotation speed of the spindle motor so as to achieve the purpose of controlling the motor. However, according to such method, mathematical operations are required to be performed to different spindle motors to obtain the spindle motor parameter corresponding to each spindle motor. Moreover, a differential amplifier is used to calculate the armature current, so that the calculated armature current probably has an error due to resistor matching and noise problems, and accordingly the spindle motor parameter and the rotation speed cannot be accurately obtained.

In another existing technique, a Taiwan Patent No. 1274468 provides a brake control method and a system for a direct current brush motor without Hall elements. According to such method, when the system is activated, the motor is first braked in advance, so as to detect a static armature current corresponding to a static state of the motor. Then, when the motor is required to be braked, an inverted control voltage is output and the armature current of the motor is detected. Wherein, if the detected armature current is equal to the static armature current, it represents that the motor is in the static state. However, a disadvantage of such method is that each time when the system is activated, time has to be spent for braking the motor in advance, so as to detect the static armature current used as a basis for determination.

### SUMMARY OF THE INVENTION

The present invention is directed to a motor rotation speed control device, in which control of a direct current (DC) brush motor can be performed by detecting a back electromotive force (EMF) of the DC brush motor without calculating mathematical expressions and using a differential amplifier, so as to increase a control accuracy of the motor rotation speed control device.

The present invention is directed to a motor rotation speed control method, by which whether a DC brush motor has stopped rotating is determined according to back EMF information. By such means, when the system is activated, it is unnecessary to spend time to brake the DC brush motor in advance, so that consumption of a timing process can be effectively reduced.

The present invention provides a motor rotation speed control device for controlling a DC brush motor having a first control terminal and a second control terminal. The motor rotation speed control device includes a motor driver, a detection unit and a central processing unit (CPU). The motor driver is coupled to the first control terminal and the second control terminal of the DC brush motor. The detection unit detects a back EMF of the DC brush motor through the first control terminal and the second control terminal when the motor driver is set to a disable state, and accordingly generates back EMF information. The CPU determines whether the DC brush motor is in a stop-rotating state according to the back EMF information, and determines whether to generate a brake control signal according to a determination result. The motor driver reduces a rotation speed of the DC brush motor according to the brake control signal when the motor driver is set to an enable state.

In an embodiment of the present invention, the detection unit includes a first resistor, a second resistor, a switch and a first analog-to-digital converter (ADC). A first terminal of the first resistor is coupled to the first control terminal, and the first terminal and a second terminal of the first resistor are respectively used for generating a first detecting voltage and a second detecting voltage. A first terminal of the second resistor is coupled to the second terminal of the first resistor, and a second terminal of the second resistor is coupled to a first reference voltage. A first terminal of the switch is coupled to the second terminal of the first resistor, and a second terminal of the switch is coupled to the second control terminal. Wherein, during a period when the motor driver is set to the disable state, the switch conducts the first terminal and the second terminal. The first ADC is used for converting the first detecting voltage and the second detecting voltage into corresponding digital values, so as to generate the back EMF information.

In an embodiment of the present invention, the detection unit includes a third resistor, a fourth resistor, a fifth resistor and a second ADC. A first terminal of the third resistor is coupled to the first control terminal. A first terminal of the fourth resistor is coupled to a second terminal of the third resistor, a second terminal of the fourth resistor is coupled to the second control terminal, and the first terminal of the fourth resistor is used for generating a third detecting voltage. A first terminal of the fifth resistor is coupled to the second terminal of the fourth resistor, a second terminal of the fifth resistor is coupled to a second reference voltage, and pulls a voltage level of the second terminal of the fourth resistor to the second reference voltage to serve as a fourth detecting voltage. The second ADC is used for converting the third detecting voltage and the fourth detecting voltage into corresponding digital values, so as to generate the back EMF information.

The present invention provides a motor rotation speed control method for controlling a DC brush motor having a first control terminal and a second control terminal. The motor rotation speed control method includes following steps. First, a motor driver is used to drive the DC brush motor. Next, when the motor driver is set to a disable state, a back EMF of the DC brush motor is detected through the first control terminal and the second control terminal to generate back EMF information. Next, whether the DC brush motor has stopped rotating is determined according to the back EMF information, and whether to generate a brake control signal is determined according to a determination result. Finally, when the motor driver is set to an enable state, a rotation speed of the DC brush motor is reduced according to the brake control signal.

According to the above descriptions, in the present invention, the back EMF of the DC brush motor is detected to generate the back EMF information, so as to control the rotation speed of the DC brush motor. It should be noticed that in the present invention, the back EMF can be detected without calculating mathematical expressions and using a differential amplifier, so that a voltage offset problem caused by unmatched resistors can be avoided, and therefore a control accuracy of the motor rotation speed control device can be increased. Moreover, it is unnecessary to spend time to brake the motor in advance when the system is activated, so that consumption of a timing process can be effectively reduced.

In order to make the aforementioned and other features and advantages of the present invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a circuit structural diagram illustrating a motor rotation speed control device according to an embodiment of the present invention.

FIG. 2 is circuit schematic diagram illustrating a DC brush motor.

FIG. 3 is a waveform schematic diagram of a resolution of a rotation speed of a DC brush motor.

FIG. 4 is a circuit structural diagram illustrating a detection unit according to an embodiment of the present invention.

FIG. 5 is a circuit structural diagram illustrating a detection unit according to another embodiment of the present invention.

FIG. 6 is a circuit structural diagram illustrating a detection unit according to still another embodiment of the present invention.

FIG. 7 is a flowchart illustrating a motor rotation speed control method according to an embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

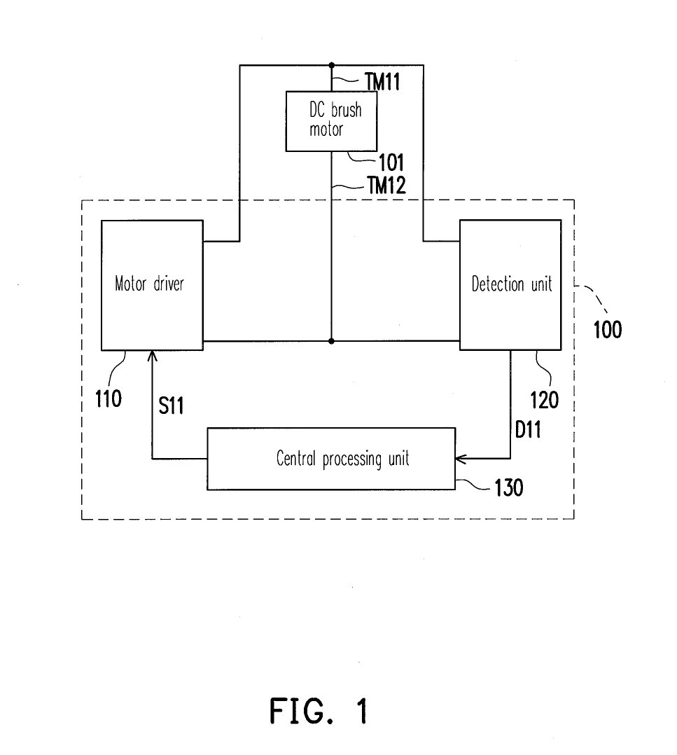

FIG. 1 is a circuit structural diagram illustrating a motor rotation speed control device according to an embodiment of the present invention. Referring to FIG. 1, the motor rotation speed control device 100 includes a motor driver 110, a detection unit 120 and a central processing unit (CPU) 130. The motor rotation speed control device 100 is used for controlling a direct current (DC) brush motor 101 having a first control terminal TM11 and a second control terminal TM12. Before an operation principle of the motor rotation speed control device 100 is described, electrical characteristics of the DC brush motor 101 are first introduced.

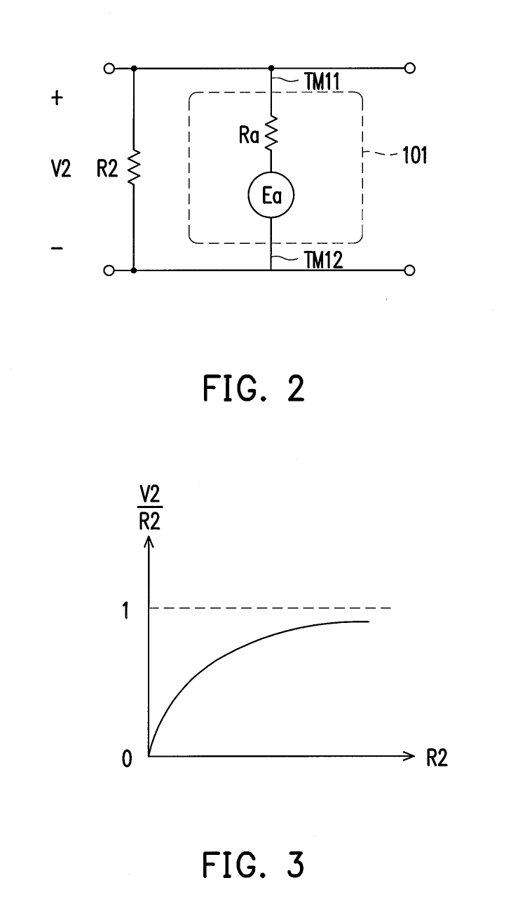

FIG. 2 is circuit schematic diagram illustrating a DC brush motor. Referring to FIG. 2, the DC brush motor 101 can be equivalent to a series circuit having an inner resistor Ra and a back electromotive force (EMF) Ea, wherein the back EMF Ea is generated when the DC brush motor 101 is rotated. Here, in a following equation (1), a magnitude of the back EMF Ea is proportional to a rotation speed ω of the DC brush motor 101, wherein Kb is a constant. Therefore, by detecting the magnitude of the back EMF Ea, the rotation speed of the DC brush motor 101 can be determined.

Ea=Kb·ω Equation (1)

Regarding a detection of the back EMF Ea, as shown in FIG. 2, if a resistor R2 is coupled to the two control terminals TM11 and TM12 of the DC brush motor 101, a voltage V2 of a loop formed by the resistor R2 and the DC brush motor 101 can be detected. Wherein, a relationship between the voltage V2 and the back EMF Ea is shown as a following equation (2). Therefore, the magnitude of the back EMF Ea can be calculated according to the voltage V2, so as to determine the rotation speed of the DC brush motor 101. Moreover, as shown in FIG. 3, when a resistance of the resistor R2 is changed, a magnitude of the voltage V2 is correspondingly changed, and a resolution of the rotation speed of the DC brush motor 101 can be accordingly determined.

$$V 2 = \frac{R 2}{R 2 + Ra} \cdot Ea \qquad Equation ( 2 )$$

Referring to FIG. 1 again, the motor driver 110 is coupled to the first control terminal TM11 and the second control terminal TM12 of the DC brush motor 101. Moreover, the motor driver 110 can be set to a disable state and an enable state, and during the disable state, the two control terminals TM11 and TM12 of the DC brush motor 101 relating to the motor driver 110 are floating. In addition, during the enable state, the motor driver 110 correspondingly controls the DC brush motor 101 according to a signal sent from the CPU 130.

To obtain related information of a current rotation speed of the DC brush motor 101, the detection unit 120 detects the back EMF Ea of the DC brush motor 101 through the first control terminal TM11 and the second control terminal TM12 when the motor driver is set to the disable state, and accordingly generates back EMF information D11. According to the aforementioned electrical characteristics of the DC brush motor 101, the CPU 130 can obtain the current rotation speed of the DC brush motor 101 according to the back EMF information D11, so as to determine whether the DC brush motor 101 has stopped rotating.

When a determination result of the CPU 130 indicates that the DC brush motor 101 still rotates, the CPU 130 generates a brake control signal S11 to the motor driver 110. Then, the motor driver 110 in the enable state reduces the rotation speed of the DC brush motor 101 according to the brake control signal S11. Comparatively, when the determination result indicates that the DC brush motor 101 has stopped rotating, the CPU 130 stops generating the brake control signal S11. Therefore, since the motor rotation speed control device 100 controls the DC brush motor 101 by detecting the back EMF Ea, the motor rotation speed control device 100 can perform corresponding operations to the DC brush motor 101 without using an extra differential amplifier and calculating complicated mathematical expressions. Moreover, during a process of controlling the motor, the motor rotation speed control device 100 is unnecessary to spend time to brake the motor in advance when the system is activated, so that consumption of a timing process can be effectively reduced.

It should be noticed that according to the above description of the electrical characteristics of the DC brush motor 101 of FIG. 2, it is known that the voltage V2 related to the back EMF Ea can be detected through the resistor R2 cross-connected between the two control terminals TM11 and TM12 of the DC brush motor 101. Therefore, in an actual application, the detection unit 120 can detects the back EMF Ea according to the above principle. To fully convey the spirit of the present invention to those with ordinary skill in the art, a plurality of embodiments are provided below to describe detail operations of the detection unit 120.

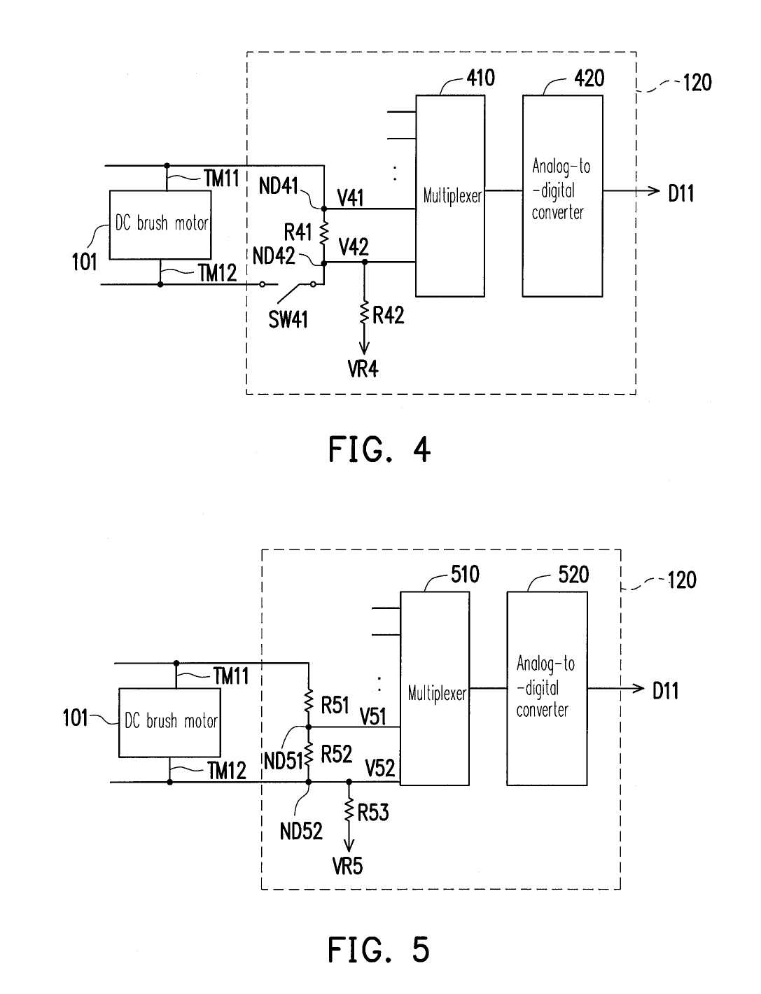

FIG. 4 is a circuit structural diagram illustrating a detection unit according to an embodiment of the present invention. For simplicity's sake, the DC brush motor 101 is further illustrated in FIG. 4. Referring to FIG. 4, the detection unit 120 includes a resistor R41, a resistor R42, a switch SW41, a multiplexer 410 and an analog-to-digital converter (ADC) 420.

Referring to FIG. 4, a first terminal of the resistor R41 is coupled to the first control terminal TM11 of the DC brush motor 101, and a second terminal of the resistor R41 is coupled to a first terminal of the resistor R42. A second terminal of the resistor R42 is coupled to a reference voltage VR4. A first terminal of the switch SW41 is coupled to the second terminal of the first resistor R41, and a second terminal of the switch SW41 is coupled to the second control terminal TM12 of the DC brush motor 101. The multiplexer 410 is coupled to nodes ND41 and ND42 of the resistors R41 and R42, and the ADC 420 is coupled to the multiplexer 410.

Referring to FIG. 1 and FIG. 4, during a period when the motor driver 110 is set to the disable state, the switch SW41 conducts its first and second terminals, so that the resistor R41 is cross-connected between the two control terminals TM11 and TM12 of the DC brush motor 101. Now, the first terminal and the second terminal of the resistor R41 respectively generate a detecting voltage V41 and a detecting voltage V42. Moreover, according to the equation (2), a voltage difference between the detecting voltages V41 and V42 is proportional to the back EMF Ea of the DC brush motor 101. During an actual operation, the ADC 420 converts the detecting voltages V41 and V42 into corresponding digital values, so as to generate the back EMF information D11.

By such means, the CPU 130 can determine a magnitude of the voltage difference between the detecting voltages V41 and V42 according to the back EMF information D11, so as to obtain related information of the magnitude of the back EMF Ea. Moreover, when the voltage difference between the detecting voltages V41 and V42 is zero, it represents that the back EMF Ea is zero, i.e. the DC brush motor 101 has stopped rotating. Therefore, when the voltage difference between the detecting voltages V41 and V42 is zero, the CPU 130 stops generating the brake control signal S11 according to the back EMF information generated by the ADC 420. It should be noticed that the multiplexer 410 transmits the detecting voltages V41 and V42 to the ADC 420 by time-division multiplexing within the predetermined period with the operation of the motor rotation speed control device 100. Moreover, the other elements in the motor rotation speed control device 100 can share the ADC 420 of the detection unit 120.

FIG. 5 is a circuit structural diagram illustrating a detection unit according to another embodiment of the present invention. For simplicity's sake, the DC brush motor 101 is further illustrated in FIG. 5. Referring to FIG. 5, the detection unit 120 includes a resistor R51, a resistor R52, a resistor R53, a multiplexer 510 and an ADC 520.

Referring to FIG. 5, a first terminal of the resistor R51 is coupled to the first control terminal TM11 of the DC brush motor 101, and a second terminal of the resistor R51 is coupled to a first terminal of the resistor R52. A second terminal of the resistor R52 is coupled to the second control terminal TM12 of the DC brush motor 101. A first terminal of the resistor R53 is coupled to the second terminal of the resistor R52, and a second terminal of the resistor R53 is coupled to a reference voltage VR5. The multiplexer 510 is coupled to nodes ND51 and ND52 of the resistors R51, R52 and R53, and the ADC 520 is coupled to the multiplexer 510.

Referring to FIG. 4 and FIG. 5, a major difference between the embodiment of FIG. 4 and the embodiment of FIG. 5 is that the resistor R41 of FIG. 4 is replaced by two resistors R51 and R52 of FIG. 5, and the two resistors R51 and R52 are cross-connected between the two control terminals TM11 and TM12 of the DC brush motor 101. Moreover, in the embodiment of FIG. 5, the switch SW41 is omitted. According to the circuit structure of FIG. 5, a voltage between the two control terminals TM11 and TM12 of the DC brush motor 101 can be divided by the resistors R51 and R52. Now, the first terminal of the resistor R52 generates a detecting voltage V51, and the second terminal of the resistor R52 generates another detecting voltage V52.

It should be noticed that by increasing a total resistance of the resistors R51-R53, a shunt effect of the detection unit 120 caused by too small resistances of the resistors R51-R53 can be avoided without using a switch. Moreover, although increasing of the total resistance of the resistors R51-R53 can increase the cross-voltage between the two control terminals TM11 and TM12 of the DC brush motor 101, the detecting voltages V51 and V52 can be suitably attenuated through the voltage division of the resistors R51 and R52, so that the detecting voltages V51 and V52 do not exceed an input voltage range of the ADC 520.

Referring to FIG. 1 and FIG. 5, during the actual operation, the ADC 520 converts the detecting voltages V51 and V52 into corresponding digital values, so as to generate the back EMF information D11. Moreover, a relationship between a voltage difference ΔV5 of the detecting voltages V51 and V52 and the back EMF Ea of the DC brush motor 101 is shown as a following equation (3). Therefore, the CPU 130 can determine the magnitude of the voltage difference between the detecting voltages V51 and V52 according to the back EMF information D11, so as to obtain related information of the magnitude of the back EMF Ea. Comparatively, the CPU 130 determines whether to generate the brake control signal S11 according to the above determination result. On the other hand, the multiplexer 510 sequentially transmits the detecting voltages V51 and V52 to the ADC 520 by time-division multiplexing, and the other elements of the motor rotation speed control device 100 can share the ADC 520 by switching of the multiplexer 510. Detailed operation principle of the present embodiment is the same to that of the aforementioned embodiment, so that detailed description thereof is not repeated.

$$Δ V 5 = \frac{R 52}{( R 51 + R 52 ) + Ra} \times Ea \qquad Equation ( 3 )$$

However, it should be noticed that regarding the electrical characteristics of the DC brush motor 101, a voltage level of the second terminal of the resistor R52 is pulled to the reference voltage VR5 through the resistor R53, namely, in the actual operation, the detecting voltage V52 is equal to the reference voltage VR5. Moreover, the ADC 520 also receives another reference voltage for performing a corresponding conversion. Therefore, as shown in FIG. 6, when the reference voltages received by the resistor R53 and the ADC 520 are all the reference voltage VR6, the ADC 520 can generate the back EMF information D11 through the detecting voltage V51 and its internal reference voltage VR6. Therefore, in the embodiment of FIG. 6, the detecting voltage generated by the second terminal of the resistor R52 is unnecessary to be transmitted to the ADC 520.

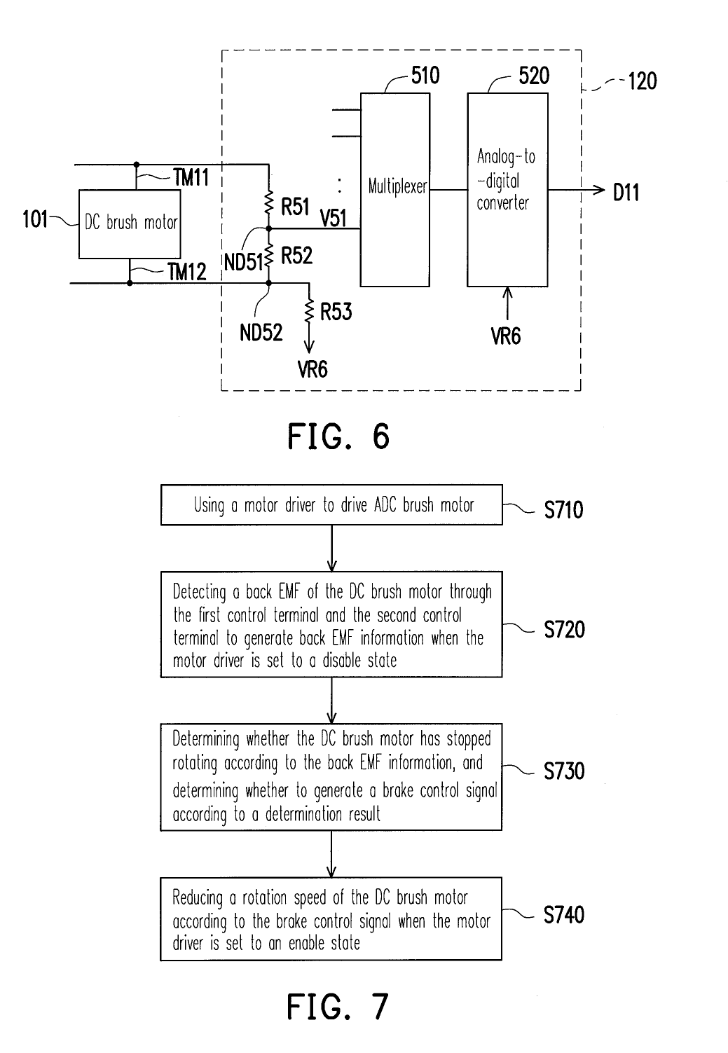

According to another aspect, FIG. 7 is a flowchart illustrating a motor rotation speed control method according to an embodiment of the present invention. The motor rotation speed control method is used for controlling a DC brush motor having a first control terminal and a second control terminal. The motor rotation speed control method includes following steps. First, in step S710, a motor driver is used to drive the DC brush motor. Next, in step S720, when the motor driver is set to a disable state, a back EMF of the DC brush motor is detected through the first control terminal and the second control terminal, so as to generate back EMF information. Next, in step S730, whether the DC brush motor has stopped rotating is determined according to the back EMF information, and whether to generate a brake control signal is determined according to a determination result. Finally, in step S740, when the motor driver is set to an enable state, a rotation speed of the DC brush motor is reduced according to the brake control signal. Detailed operation flow of the present embodiment is the same as that described in the aforementioned embodiments, and therefore detailed descriptions thereof are not repeated.

In summary, in the present invention, the back EMF of the DC brush motor is detected to control the rotation speed of the DC brush motor. Moreover, the back EMF can be detected without calculating mathematical expressions and using a differential amplifier, so that a voltage offset problem caused by unmatched resistors can be avoided. In addition, in the present invention, it is unnecessary to spend time to brake the motor in advance when the system is activated, so that consumption of a timing process can be effectively reduced.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A motor rotation speed control device, for controlling a direct current (DC) brush motor having a first control terminal and a second control terminal, the motor rotation speed control device comprising:
a motor driver, coupled to the first control terminal and the second control terminal;
a detection unit, detecting a back electromotive force (EMF) of the DC brush motor through the first control terminal and the second control terminal when the motor driver is set to a disable state, and generating back EMF information; and
a central processing unit (CPU), determining whether the DC brush motor is in a stop-rotating state according to the back EMF information, and determining whether to generate a brake control signal according to a determination result, wherein the motor driver reduces a rotation speed of the DC brush motor according to the brake control signal when the motor driver is set to an enable state.

2. The motor rotation speed control device as claimed in claim 1, wherein the detection unit comprises:
a first resistor, having a first terminal coupled to the first control terminal, and the first terminal and a second terminal of the first resistor being respectively used for generating a first detecting voltage and a second detecting voltage;
a second resistor, having a first terminal coupled to the second terminal of the first resistor, and a second terminal coupled to a first reference voltage;
a switch, having a first terminal coupled to the second terminal of the first resistor, and a second terminal coupled to the second control terminal, wherein during a period when the motor driver is set to the disable state, the switch conducts the first terminal and the second terminal thereof; and
a first analog-to-digital converter (ADC), converting the first detecting voltage and the second detecting voltage into corresponding digital values, so as to generate the back EMF information.

3. The motor rotation speed control device as claimed in claim 2, wherein the detection unit further comprises:
a first multiplexer, transmitting the first detecting voltage and the second detecting voltage to the first ADC within a predetermined period in cooperation with an operation of the motor rotation speed control device.

4. The motor rotation speed control device as claimed in claim 1, wherein the detection unit comprises:
a third resistor, having a first terminal coupled to the first control terminal;
a fourth resistor, having a first terminal coupled to a second terminal of the third resistor, and a second terminal coupled to the second control terminal, wherein the first terminal of the fourth resistor is used for generating a third detecting voltage;
a fifth resistor, having a first terminal coupled to the second terminal of the fourth resistor, a second terminal coupled to a second reference voltage, and pulling a voltage level of the second terminal of the fourth resistor to the second reference voltage to serve as a fourth detecting voltage; and
a second ADC, converting the third detecting voltage and the fourth detecting voltage into corresponding digital values, so as to generate the back EMF information.

5. The motor rotation speed control device as claimed in claim 4, wherein the detection unit further comprises:
a second multiplexer, transmitting the third detecting voltage and the fourth detecting voltage to the second ADC within a predetermined period in cooperation with an operation of the motor rotation speed control device.

6. The motor rotation speed control device as claimed in claim 4, wherein the detection unit further comprises:
a third multiplexer, transmitting the third detecting voltage to the second ADC within a predetermined period in cooperation with an operation of the motor rotation speed control device, wherein the second ADC further receives the second reference voltage for performing related voltage conversion.

7. The motor rotation speed control device as claimed in claim 1, wherein the detection unit comprises a plurality of resistors connected in series, and a part of nodes of the resistors are coupled to the first control terminal and the second control terminal, the detection unit generates the back EMF information according to a plurality of detecting voltages on the part of the nodes, and when a voltage difference of the detecting voltages is zero, the CPU stops generating the brake control signal according to the back EMF information.

8. A motor rotation speed control method, for controlling a DC brush motor having a first control terminal and a second control terminal, the motor rotation speed control method comprising:
using a motor driver to drive the DC brush motor;
detecting a back EMF of the DC brush motor through the first control terminal and the second control terminal to generate back EMF information when the motor driver is set to a disable state;
determining whether the DC brush motor has stopped rotating according to the back EMF information, and determining whether to generate a brake control signal according to a determination result; and
reducing a rotation speed of the DC brush motor according to the brake control signal when the motor driver is set to an enable state.

9. The motor rotation speed control method as claimed in claim 8, wherein the step of detecting the back EMF of the DC brush motor through the first control terminal and the second control terminal to generate the back EMF information comprises:
coupling a part of nodes of a plurality of resistors connected in series to the first control terminal and the second control terminal;
obtaining a plurality of detecting voltages on the part of the nodes; and
respectively converting the detecting voltages into corresponding digital values, so as to generate the back EMF information.

10. The motor rotation speed control method as claimed in claim 9, wherein the step of determining whether the DC brush motor has stopped rotating according to the back EMF information, and determining whether to generate the brake control signal according to the determination result comprises:
determining whether a voltage difference of the detecting voltages is zero according to the back EMF information;
determining the DC brush motor still rotates when the voltage difference of the detecting voltages is not zero, and generating the brake control signal; and
determining the DC brush motor has stopped rotating when the voltage difference of the detecting voltages is zero, and stops generating the brake control signal.
